(19) United States
(12) Patent Application Publication
(10) Pub. No.: US 2018/0145560 A1
(43) Pub. Date: May 24, 2018

(54) Energy-saving Device with Functions of Air Feeding and Power Generation

(71) Applicant: Shih-Tung Chien, Tainan City (TW)

(72) Inventor: Shih-Tung Chien, Tainan City (TW)

(21) Appl. No.: 15/355,115

(22) Filed: Nov. 18, 2016

(51) Int. Cl. H02K 7/18; F01C 1/344; F01C 13/00; F01C 21/08; F01C 21/10

(52) U.S. Cl. CPC H02K 7/1823; F01C 1/344; F01C 21/10; F01C 21/08; F01C 13/00

(57) ABSTRACT

An energy-saving device with functions of air feeding and power generation includes an air feeder, an actuator unit, an air-operated device, a generator, and a power storage unit. The actuator unit includes a mounting base, a cylindrical body received in the mounting base, and an axle body rotatably received in the cylindrical body. The mounting base is connected to the air feeder through an air duct for introduction of gases from the air feeder to the cylindrical body. When the air feeder is activated, the axle body of the actuator unit is rotated to supply high-pressure gases to the air-operated device and simultaneously drive the generator to generate electricity, which is stored in the power storage unit for the air-operated device and/or a power-consuming end, for fullest use of electricity and energy sufficiency.

### BACKGROUND OF THE INVENTION

### 1. Field of the Invention

The present invention relates to an energy-saving device and, more particularly, to an energy-saving device supplying air to an air-operated device, simultaneously driving a generator to generate electricity and storing electric power in a power storage unit.

### 2. Description of the Related Art

An air-operated device such as a pneumatic machine tool should be activated with high-pressure air supplied by an air feeder, such as an air compressor, in general. The various air compressors generally are classified into two types, displacement compressors and dynamic compressors according to their operating principles. The operating principle of a displacement compressor is to compress air volume for increased density of gas molecules per unit volume and higher pressure of compressed air. The operating principle of a dynamic compressor is to increase flow rates of gas molecules and transform dynamic energy of gas molecules into pressure energy of gases for higher pressure of compressed air. A conventional air compressor, which costs considerable electric energy in running, serves a pneumatic machine tool with a single function of supplying high-pressure air. Thus, how to take full advantage of and recycle an air compressor's (an air feeder's) dynamic energy in operation deserves to be studied by people skilled in the art for energy efficiency.

### BRIEF SUMMARY OF THE INVENTION

Thus, an objective of the present invention is to provide an energy-saving device with functions of air feeding and power generation. The energy-saving device is able to supply air to an air-operated device such as a pneumatic machine tool and simultaneously drive a generator to generate electricity which is stored in a power storage unit for fullest use of electricity and energy efficiency.

To achieve this and other objectives, an energy-saving device of the present invention includes an air feeder, an actuator unit, an air-operated device, a generator, and a power storage unit. The actuator unit includes a mounting base, a cylindrical body, and an axle body. The mounting base is connected to the air feeder through an air duct for introduction of gases from the air feeder to a chamber in the mounting base. The mounting base includes a clearance hole formed therein and linking the chamber for combination of a gas outlet. The cylindrical body is received in the chamber of the mounting base and has a vent hole aligned to the clearance hole. The axle body is rotatably held in the cylindrical body and can be driven to rotations with gases from the air feeder introduced into the cylindrical body. The air-operated device is connected to the actuator unit through the gas outlet so that gases from the gas outlet are supplied to the air-operated device. The generator has a rotary spindle which is driven to rotations by the axle body for power generation. The power storage unit is connected to the generator through a first power line so that electric power generated by the generator is stored in the power storage unit.

In an embodiment, the axle body has a first end coupled with a first bearing and a second end coupled with a second bearing. The first bearing has at least one slotted hole therein for guiding gases from the air duct to the cylindrical body.

In an embodiment, the mounting base includes a front opening in a front end thereof and a rear opening in a rear end thereof. The air duct is engaged in the front opening, and the second end of the axle body is extended out of the rear opening and connected to the rotary spindle.

The present invention will become clearer in light of the following detailed description of an illustrative embodiment of this invention described in connection with the drawings.

DESCRIPTION OF THE DRAWINGS The illustrative embodiment may best be described by reference to the accompanying drawings where:

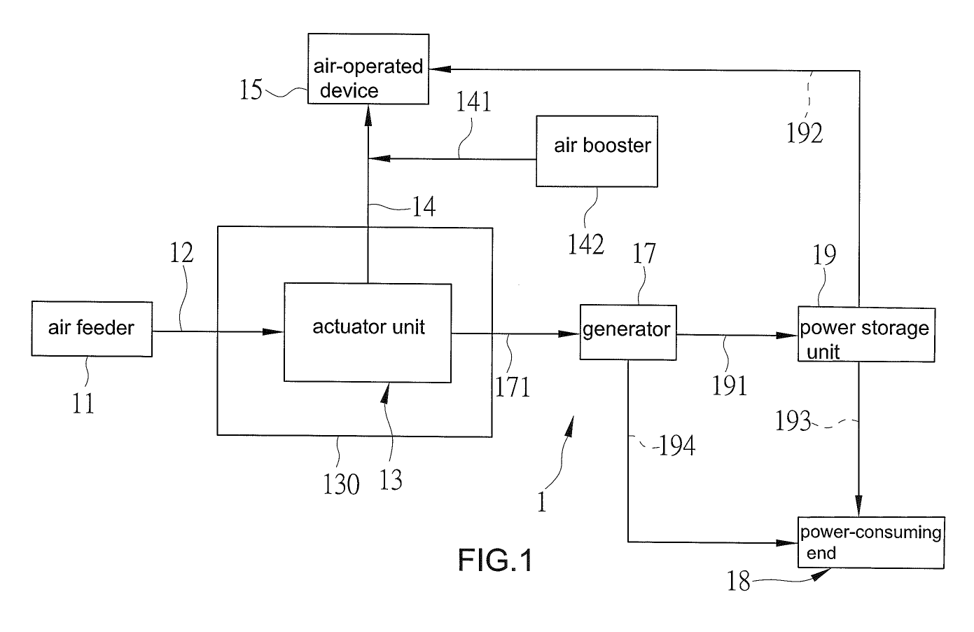

FIG. 1 is a block diagram for an energy-saving device according to an embodiment of the present invention.

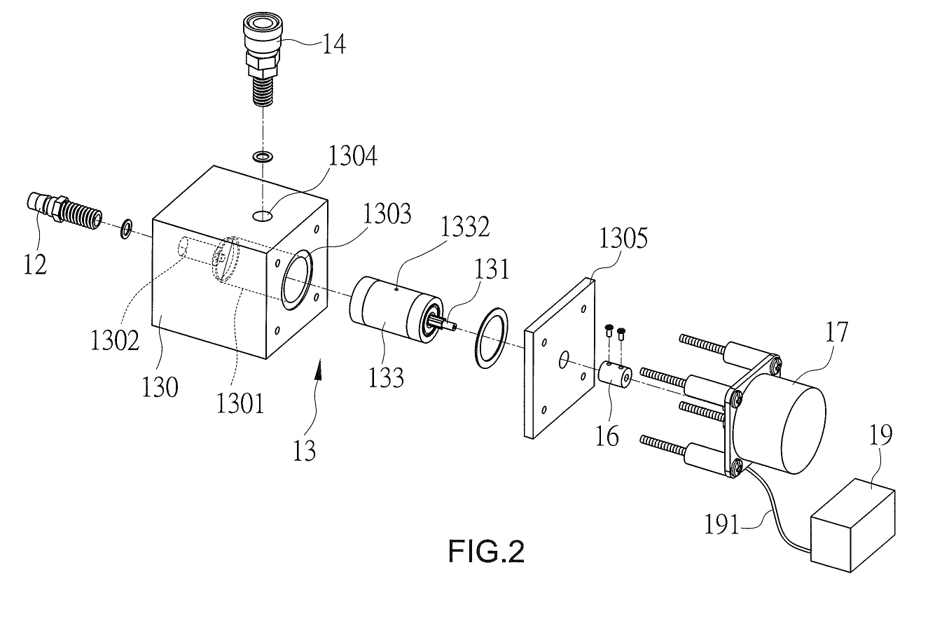

FIG. 2 is an exploded view illustrating partial structure of the energy-saving device of FIG. 1.

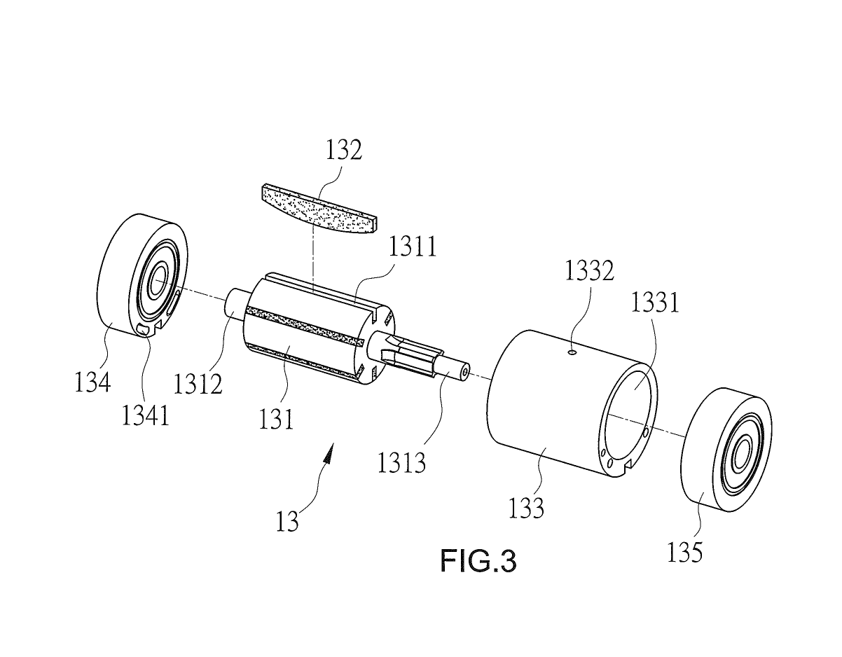

FIG. 3 is an exploded view for partial components of an actuator unit of the energy-saving device of FIG. 2.

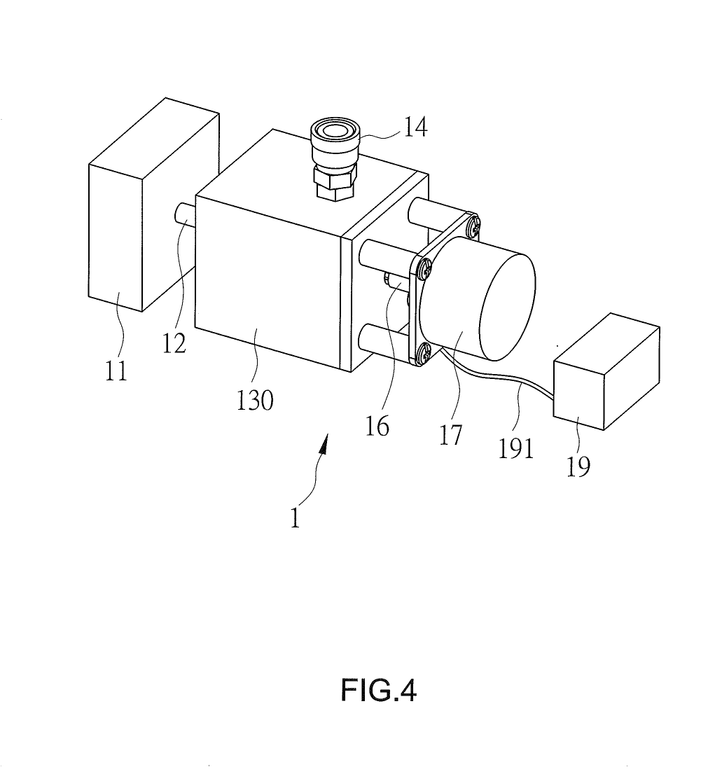

FIG. 4 is a perspective view illustrating the energy-saving device of FIG. 2.

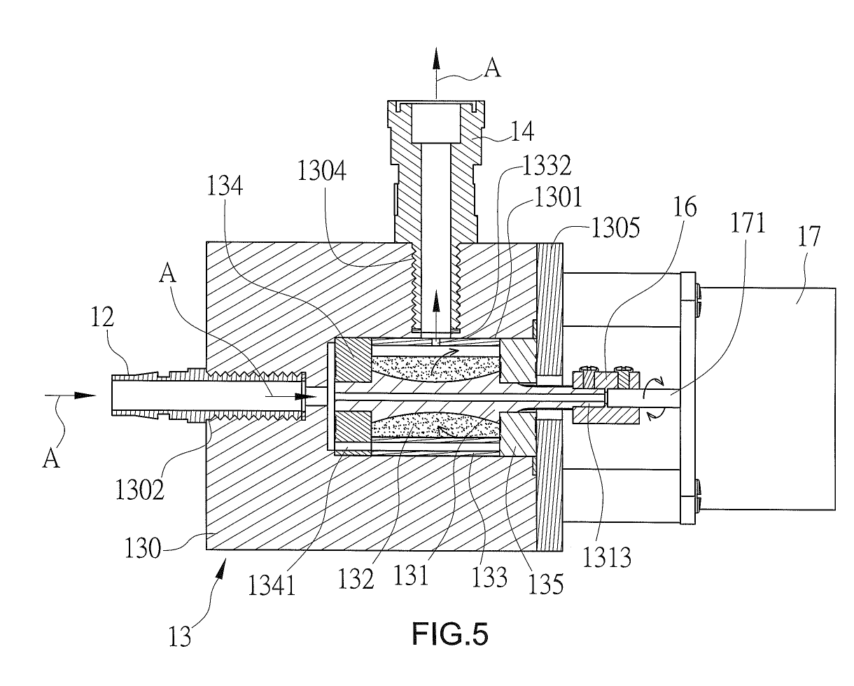

FIG. 5 is a sectional, schematic view of the energy-saving device of FIG. 2.

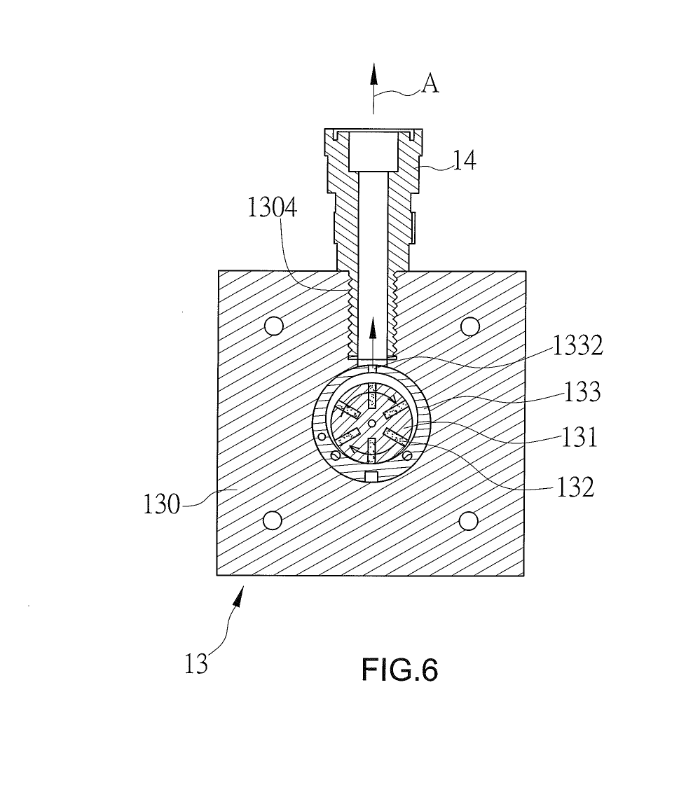

FIG. 6 is a sectional view for a longitudinal profile of the actuator unit of the energy-saving device of FIG. 2.

### DETAILED DESCRIPTION OF THE INVENTION

An energy-saving device according to the preferred teachings of the present invention is shown in FIGS. 1 through 6 of the drawings and generally designated 1. The energy-saving device 1 includes an air feeder 11, an actuator unit 13, an air-operated device 15, a generator 17, and a power storage unit 19. The air feeder 11 could be an air compressor, an oxygen feeder, or an oxygen pump in an aquaculture farm for delivery of gases or compressed gases particularly.

The actuator unit 13 is connected to the air feeder 11 through an air duct 12. The actuator unit 13 can be used to increase flow rates of gas molecules for higher gas pressures. In this embodiment, the actuator unit 13 includes a mounting base 130, a cylindrical body 133, and an axle body 131. The mounting base 130 includes a chamber 1301 therein, a front opening 1302 in a front end thereof, and a rear opening 1303 in a rear end thereof. The air duct 12 is engaged in the front opening 1302, so that gases supplied by the air feeder 11 can be guided into the chamber 1301. Moreover, the mounting base 130 further includes a clearance hole 1304 opened in an outer circumference thereof and in communication with the chamber 1301, and a gas outlet 14 is connected in the clearance hole 1304, so that gases in the mounting base 130 can be vented from the gas outlet 14. The cylindrical body 133 is received in the chamber 1301 of the mounting base 130 and includes a vent hole 1332 which is aligned to the clearance hole 1304. The axle body 131 is a rotary component held in an inner bore 1331 of the cylindrical body 133 and includes a plurality of slots 1311, each of which is opened in an outer surface of the axle body 131 for holding a blade 132 inside. Furthermore, the axle body 131 has a first end 1312 and a second end 1313 axially spaced from the first end 1312. The first end 1312 and the second end 1313 are coupled with a first bearing 134 and a second bearing 135, respectively. The cylindrical body 133, the axle body 131, the first and second bearings 134 and 135, all of which are installed in the chamber 1301 of the mounting base 130, are positioned with a case body 1305 fixed at the rear end of the mounting base 130. Additionally, the first bearing 134 includes at least one slotted hole 1341 through which gases flowing in the air duct 12 can be guided into the inner bore 1331 of the cylindrical body 133 (FIG. 5). Thus, the axle body 131 can be driven to rotations when by the gases is guided into the inner bore 1331 of the cylindrical body 133.

The air-operated device 15 is a pneumatic device such as pneumatic machine tool. The air-operated device 15 is connected to the actuator unit 13 by the gas outlet 14 and is enabled with gases from the gas outlet 14 supplied. In this embodiment, the gas outlet 14 is connected to a tube 141 and further an air booster 142 for higher air pressure introduced to the air-operated device 15 from the gas outlet 14.

The second end 1313 of the axle body 131 is extended out of the rear opening 1303 of the mounting base 130 and connected to a rotary spindle 171 through an adapter cylinder 16, so that the rotary spindle 171 can be driven to rotations by the axle body 131. In this embodiment, the generator 17 depends on a first power line 191 to link the power storage unit 19, which is further connected to the air-operated device 15 through a second power line 192. The power storage unit 19 links a power-consuming end 18 through a third power line 193, and the generator 17 links the power-consuming end 18 through a fourth power line 194. The power-consuming end 18 could be an electric appliance or a peripheral device of the air-operated device 15.

In practice of the energy-saving device 1 of the present invention, molecules of gases (A) from the activated air feeder 11 are introduced to the inner bore 1331 of the cylindrical body 133 through the air duct 12 as well as the slotted holes 1341 in the first bearing 134 (as shown in FIG. 5) and outward accelerated by the blades 132 on the axle body 131 of the actuator unit 13, which has been driven to rotations by the gases, for high pressure of gases (A) discharged from the gas outlet 14 and used in the air-operated device 15. Simultaneously, the rotary spindle 171 of the generator 17 is driven to rotations by the axle body 131 for generating electricity, which is further transmitted in the first power line 191 and stored in the power storage unit 19 as a power source of the air-operated device 15 or the power-consuming end 18, or directly supplied to the power-consuming end 18 through the fourth power line 194.

The scope of the invention is to be indicated by the appended claims, rather than by the foregoing description, and all changes which come within the meaning and range of equivalency of the claims are intended to be embraced therein.

1. An energy-saving device with functions of air feeding and power generation comprising:
an air feeder for delivery of gases;
an actuator unit including a mounting base, a cylindrical body, and an axle body, with the mounting base connected to the air feeder through an air duct for introduction of gases from the air feeder to a chamber in the mounting base, with the mounting base including a clearance hole linking the chamber for combination of a gas outlet, with the cylindrical body received in the chamber of the mounting base and having a vent hole aligned to the clearance hole, with the axle body rotatably held in the cylindrical body and being driven to rotations with gases from the air feeder introduced into the cylindrical body;
an air-operated device connected to the actuator unit through the gas outlet so that gases from the gas outlet are supplied to the air-operated device;
a generator having a rotary spindle which is driven to rotations by the axle body for power generation; and
a power storage unit connected to the generator through a first power line so that electric power generated by the generator is stored in the power storage unit.

2. The energy-saving device according to claim 1, wherein the axle body has a first end coupled with a first bearing, with the first bearing having at least one slotted hole therein for guiding gases from the air duct into the cylindrical body.

3. The energy-saving device according to claim 1, wherein the mounting base includes a front opening in a front end thereof and a rear opening in a rear end thereof, with the air duct engaged in the front opening, with the second end of the axle body extended out of the rear opening and connected to the rotary spindle.

4. The energy-saving device according to claim 1, wherein the axle body includes a plurality of slots opened in an outer surface of the axle body for holding a blade inside.

5. The energy-saving device according to claim 1, wherein the power storage unit is connected to the air-operated device through a second power line.

6. The energy-saving device according to claim 5, wherein the power storage unit links a power-consuming end through a third power line, and wherein the generator links the power-consuming end through a fourth power line.

7. The energy-saving device according to claim 1, wherein the gas outlet is connected to an air booster through a tube for higher air pressure introduced to the air-operated device from the gas outlet.
